(19) United States
(12) Patent Application Publication
(10) Pub. No.: US 2003/0131128 A1
(43) Pub. Date: Jul. 10, 2003

(54) VLAN MPLS MAPPING: METHOD TO ESTABLISH END-TO-TRAFFIC PATH SPANNING LOCAL AREA NETWORK AND A GLOBAL NETWORK

(76) Inventor: Kevin B. Stanton, Hillsboro, OR (US)

Correspondence Address: Pillsbury Winthrop LLP, Intellectual Property Group, Suite 2800, 725 S. Figueroa Street, Los Angeles, CA, 90017-5406, US

(21) Appl. No.: 10/044,749

(22) Filed: Jan. 10, 2002

(51) Int. Cl. G06F 15/173

(52) U.S. Cl. 709/238

(57) ABSTRACT

A remote virtual network interface includes an Ethernet receiving element in communication with an Ethernet node. An Ethernet transmitting element is in communication with the Ethernet node. An InfiniBand receiving element receives a data packet from a first InfiniBand node. The data packet includes a destination indicator. A detector is included to read the destination indicator and to compare the destination indicator to a known value.

If the destination indicator matches the known value, a routing element may deliver the data packet from the InfiniBand receiving element to an InfiniBand transmitting element. The InfiniBand transmitting element is included to transmit the data packet from the first InfiniBand node to a second InfiniBand node. On the other hand, if the destination indicator does not match the known value, the Ethernet transmitting element may deliver the data packet to the Ethernet node.

### BACKGROUND OF THE INVENTION

1. Field of the Invention

The present invention generally relates to a network interface to provide access to an Ethernet networking system. More particularly, the present invention relates to a remote virtual network interface that provides Ethernet connectivity to multiple InfiniBand nodes.

2. Discussion of the Related Art

Nodes, such as personal computers and engineering workstations, are conventionally interconnected to form local area networks (“LANs”) that allow messages to be sent and programs to be downloaded, for example, from file servers on the LAN. Ethernet is a shared-media network architecture, defined in the Institute of Electrical and Electronics Engineers (“IEEE”) 802.3 standard, republished Oct. 16, 2000, and is currently the most widely used architecture for LANs. Ethernet uses both bus and star topologies, in which nodes are attached to a trunk segment, which is the primary piece of cable in an Ethernet network.

In a star configuration, several nodes are interconnected through a common hub or concentrator. A hub serves as a common termination point for multiple nodes and relays signals along the appropriate paths. Generally, the hub is a unit, having a number of connectors to which nodes are attached. Hubs usually accommodate a plurality of nodes (e.g., 4, 8, 12, 24, or more nodes), and many hubs include connectors for linking to other hubs. Each node in the network is typically a computer of some type, such as a personal computer (“PC”), Macintosh, minicomputer, or mainframe, where the computer generally includes a network interface card (“NIC”) for interfacing the node to the hub to enable networking capabilities. In other words, each NIC generally interfaces only one node.

InfiniBand is a shared-media network architecture, developed to manage the increased traffic placed on LANs. InfiniBand is used to interconnect processor nodes and I/O nodes, forming a system area network (“SAN”) that functions independently of the host operating system (“OS”) and processor platform. InfiniBand is a point-to-point, switched I/O fabric that interconnects end node devices by cascaded switch devices. The InfiniBand Trade Association's (“IBTA”) specification 1.0.a, republished Jun. 19, 2001, defines the InfiniBand architecture, which offers greater bandwidth, increased scalability, and decreased CPU utilization, as compared to Ethernet. The IBTA projects that the bandwidth capacity of InfiniBand will remain superior to the bandwidth capacity of Ethernet by a factor of ten. However, when a NIC is used to provide Ethernet connectivity to multiple InfiniBand nodes, problems may arise if an InfiniBand node attempts to deliver data through the NIC to another InfiniBand node.

For example, when a packet is received by the NIC from an Ethernet node, the NIC determines to which node the data is destined and delivers the data to the destination node. When a packet is received by the NIC from an InfiniBand node, the NIC data is typically destined for an Ethernet node. However, if the packet is not destined for an Ethernet node, but rather is destined for another InfiniBand node (which may be on the same Internet Protocol (“IP”) subnet), the Ethernet switch may fail to deliver the packet to the destined InfiniBand node, assuming that the destined InfiniBand node has already received the packet because the data came from a link in the direction of the destined InfiniBand node.

One solution may be to load a separate driver to implement an intra-InfiniBand LAN network emulation. However, this technique requires that the binding order/precedence from hostname to IP address ensures that traffic between the two InfiniBand nodes follows the intra-InfiniBand LAN emulation route, rather than the NIC route.

Another solution may be to disallow communication between the InfiniBand nodes on the subnet associated with the Ethernet port that is connected to the InfiniBand nodes. However, this technique eliminates the possibility of achieving the original goal of transferring information from one InfiniBand node to another.

Thus, a network interface that is capable of routing a data packet from one InfiniBand node to another InfiniBand node is required.

### BRIEF DESCRIPTION OF THE DRAWINGS

FIG. 1 illustrates a remote virtual network interface according to an embodiment of the present invention;

FIG. 2 illustrates a network system according to an embodiment of the present invention; and

FIG. 3 illustrates a flow chart for a method of routing a data packet from a first InfiniBand node to a second InfiniBand node according to an embodiment of the present invention.

### DETAILED DESCRIPTION

Reference in the specification to “one embodiment”, “an embodiment”, or “another embodiment” of the present invention means that a particular feature, structure or characteristic described in connection with the embodiment is included in at least one embodiment of the present invention. Thus, the appearances of the phrase “in one embodiment” or “according to an embodiment” appearing in various places throughout the specification are not necessarily all referring to the same embodiment. Likewise, appearances of the phrase “in another embodiment” or “according to another embodiment” appearing in various places throughout the specification are not necessarily referring to different embodiments.

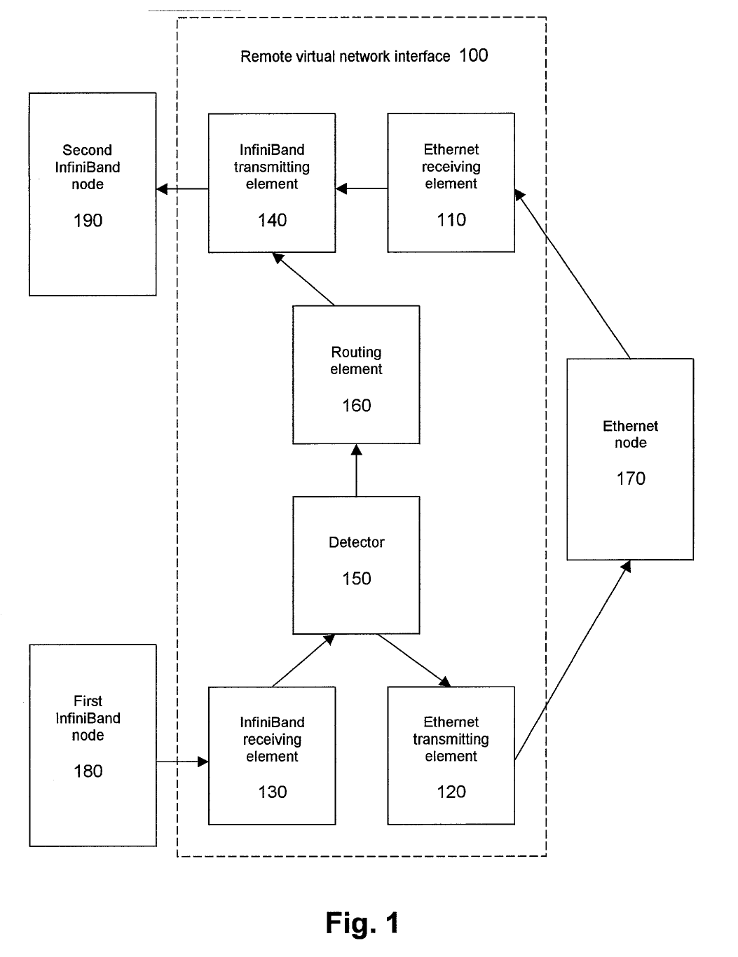

FIG. 1 illustrates a remote virtual network interface according to an embodiment of the present invention. The remote virtual network interface 100 includes an Ethernet receiving element 110, an Ethernet transmitting element 120, an InfiniBand receiving element 130, an InfiniBand transmitting element 140, a detector 150, and a routing element 160. The Ethernet receiving element 110 is in communication with an Ethernet node 170. The Ethernet transmitting element 120 is also in communication with the Ethernet node 170. The InfiniBand receiving element 130 receives a data packet from a first InfiniBand node 180. The data packet includes a destination indicator. The detector 150 reads the destination indicator and compares the destination indicator to a known value. The routing element 160 delivers the data packet from the InfiniBand receiving element 130 to the InfiniBand transmitting element 140. The InfiniBand transmitting element 140 transmits the data packet from the first InfiniBand node 180 to a second InfiniBand node 190.

According to an embodiment of the present invention, the destination indicator may be a destination media access control (“MAC”) address. The known value may be a range of MAC addresses, where a range of MAC addresses is defined to be one or more MAC addresses. In one embodiment, the detector 150 and the routing element 160 may be within a single device. The remote virtual network interface 100 may be virtualized by implementing microcode in a network processor and/or a set of integrated circuits. A set of integrated circuits is defined as one or more integrated circuits.

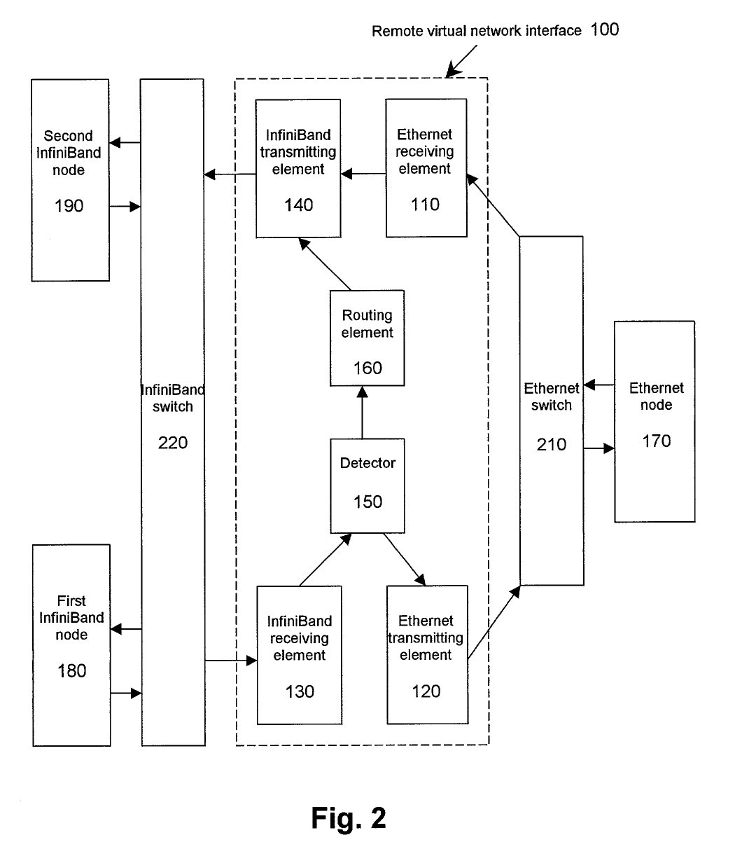

FIG. 2 illustrates a network system according to an embodiment of the present invention. The network system 200 includes an Ethernet node 170, an Ethernet switch 210, a first InfiniBand node 180, a second InfiniBand node 190, an InfiniBand switch 220, and a remote virtual network interface 100. The Ethernet node 170 may receive a first data packet from the remote virtual network interface 100. The Ethernet switch 210 may select the Ethernet node 170 to receive a second data packet. The first InfiniBand node 180 may transmit a data packet to the remote virtual network interface 100. The data packet includes a destination indicator. The InfiniBand switch 220 may select the second InfiniBand node 190 to receive the data packet from the first InfiniBand node 180.

According to an embodiment of the present invention, the first data packet and the second data packet are same.

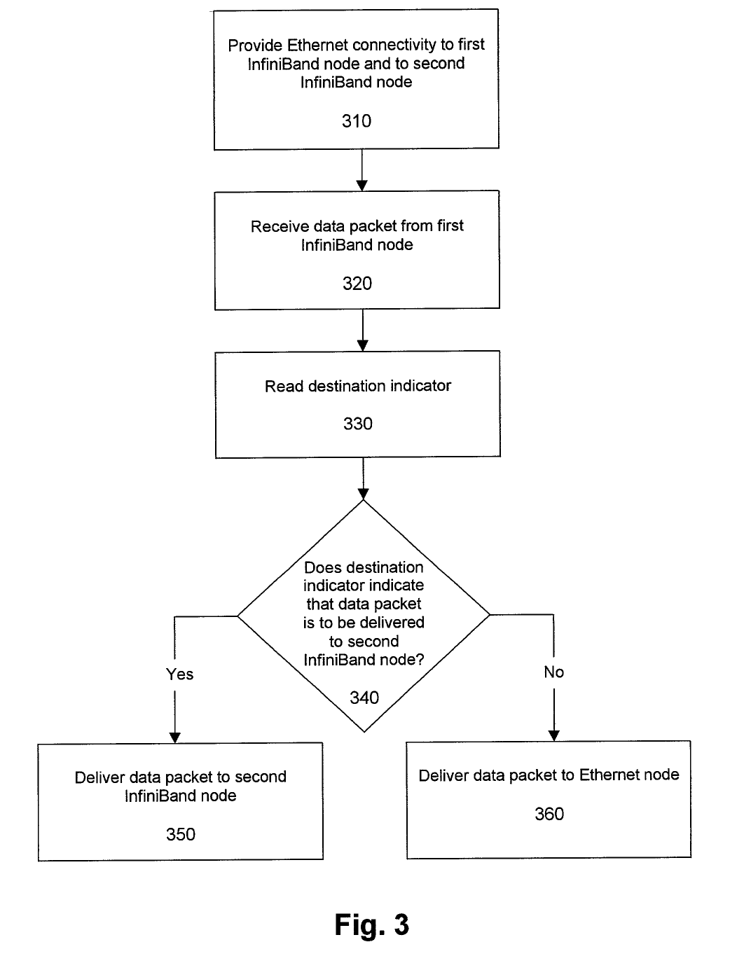

FIG. 3 illustrates a flow chart for a method of routing a data packet from a first InfiniBand node to a second InfiniBand node according to an embodiment of the present invention. Within the method and referring to FIG. 1 and FIG. 2, Ethernet connectivity is provided 310 to the first InfiniBand node 180 and to the second InfiniBand node 190. A remote virtual network interface 100 may receive 320 a data packet from the first InfiniBand node 180. The data packet includes a destination indicator. The detector 150 may read 330 the destination indicator. The destination indicator may indicate 340 that the data packet is to be delivered to the second InfiniBand node 190 by comparing the destination indicator to a known value. If the data packet is to be delivered to the second InfiniBand node 190, then the routing element 160 may deliver 350 the data packet to the second InfiniBand node 190. If the data packet is not to be delivered to the second InfiniBand node 190, then the data packet may be delivered 360 to the Ethernet node 170.

According to an embodiment of the present invention, the destination indicator may be a destination MAC address. The known value may be a range of MAC addresses, where a range of MAC addresses is defined to be one or more MAC addresses. The method of routing the data packet from the first InfiniBand node 180 to the second InfiniBand node 190 may include virtualizing the remote virtual network interface 100 by implementing microcode in a network processor and/or a set of integrated circuits. A set of integrated circuits is defined as one or more integrated circuits.

In short, the remote virtual network interface 100 according to the present invention provides Ethernet connectivity to multiple InfiniBand nodes. Specifically, the remote virtual network interface 100 is capable of routing a data packet from a first InfiniBand node 180 to a second InfiniBand node 190, even if the first InfiniBand node 180 and the second InfiniBand node 190 are on the same subnet. Furthermore, communication is allowed between the first InfiniBand node 180 and the second InfiniBand node 190 regardless of whether an intra-InfiniBand LAN network is emulated, and regardless of the order and priority of binding.

While the description above refers to particular embodiments of the present invention, it will be understood that many modifications may be made without departing from the spirit thereof. The accompanying claims are intended to cover such modifications as would fall within the true scope and spirit of the present invention. The presently disclosed embodiments are therefore to be considered in all respects as illustrative and not restrictive, the scope of the invention being indicated by the appended claims, rather than the foregoing description, and all changes that come within the meaning and range of equivalency of the claims are therefore intended to be embraced therein.

What is claimed is:

1. A remote virtual network interface, comprising:
an Ethernet receiving element in communication with an Ethernet node;
an Ethernet transmitting element in communication with the Ethernet node;
an InfiniBand receiving element to receive a data packet from a first InfiniBand node, wherein the data packet includes a destination indicator;
a detector to read the destination indicator and to compare the destination indicator to a known value; and
a routing element to deliver the data packet from the InfiniBand receiving element to an InfiniBand transmitting element, wherein the InfiniBand transmitting element transmits the data packet from the first InfiniBand node to a second InfiniBand node.

2. The remote virtual network interface according to claim 1, wherein the destination indicator is a destination media access control (“MAC”) address.

3. The remote virtual network interface according to claim 1, wherein the known value is a range of media access control (“MAC”) addresses.

4. The remote virtual network interface according to claim 1, wherein the detector and the routing element are within a single device.

5. The remote virtual network interface according to claim 1, wherein the remote virtual network interface is virtualized by implementing microcode in a network processor.

6. The remote virtual network interface according to claim 1, wherein the remote virtual network interface is virtualized by implementing microcode in a set of integrated circuits.

7. A network system, comprising:
an Ethernet node to receive a first data packet from a remote virtual network interface;
an Ethernet switch to select the Ethernet node to receive a second data packet;
a first InfiniBand node to transmit a data packet to the remote virtual network interface, wherein the data packet includes a destination indicator; and
an InfiniBand switch to select a second InfiniBand node to receive the data packet from the first InfiniBand node, wherein the remote virtual network interface includes
an Ethernet receiving element in communication with the Ethernet node,
an Ethernet transmitting element in communication with the Ethernet node,
an InfiniBand receiving element to receive the data packet from the first InfiniBand node,
a detector to read the destination indicator and to compare the destination indicator to a known value,
a routing element to deliver the data packet from the first InfiniBand node to the second InfiniBand node, and
an InfiniBand transmitting element to transmit the data packet from the first InfiniBand node to the second InfiniBand node.

8. The network system according to claim 7, wherein the destination indicator is a destination media access control (“MAC”) address.

9. The network system according to claim 7, wherein the known value is a range of media access control (“MAC”) addresses.

10. The network system according to claim 7, wherein the detector and the routing element are within a single device.

11. The network system according to claim 7, wherein the remote virtual network interface is virtualized by implementing microcode in a network processor.

12. The network system according to claim 7, wherein the remote virtual network interface is virtualized by implementing microcode in a set of integrated circuits.

13. The network system according to claim 7, wherein the first data packet and the second data packet are same.

14. A method of routing a data packet from a first InfiniBand node to a second InfiniBand node, comprising:
providing Ethernet connectivity to the first InfiniBand node and to the second InfiniBand node;
receiving a data packet from the first InfiniBand node, wherein the data packet includes a destination indicator;
reading the destination indicator;
indicating by the destination indicator that the data packet is to be delivered to the second InfiniBand node; and
delivering the data packet to the second InfiniBand node.

15. The method according to claim 14, wherein the receiving of the data packet from the first InfiniBand node is performed by a remote virtual network interface.

16. The method according to claim 14, wherein the reading of the destination indicator is performed by a detector.

17. The method according to claim 14, wherein the delivering of the data packet to the second InfiniBand node is performed by a routing element.

18. The method according to claim 14, wherein the destination indicator is a destination media access control (“MAC”) address.

19. The method according to claim 14, wherein the indicating by the destination indicator that the data packet is to be delivered to the second InfiniBand node is performed by comparing the destination indicator to a known value.

20. The method according to claim 19, wherein the known value is a range of media access control (“MAC”) addresses.

21. The method according to claim 14, wherein the method further includes virtualizing the remote virtual network interface by implementing microcode in a network processor.

22. The method according to claim 14, wherein the method further includes virtualizing the remote virtual network interface by implementing microcode in a set of integrated circuits.

23. A program code storage device, comprising:
a machine-readable storage medium; and
machine-readable program code, stored on the machine-readable storage medium, the machine-readable program code having instructions to
provide Ethernet connectivity to a first InfiniBand node and to a second InfiniBand node;
receive a data packet from the first InfiniBand node, wherein the data packet includes a destination indicator,
read the destination indicator,
indicate by the destination indicator that the data packet is to be delivered to the second InfiniBand node, and
deliver the data packet to the second InfiniBand node.

24. The program code storage device according to claim 23, wherein a remote virtual network interface receives the data packet from the first InfiniBand node.

25. The program code storage device according to claim 23, wherein a detector reads the destination indicator.

26. The program code storage device according to claim 23, wherein a routing element delivers the data packet to the second InfiniBand node.

27. The program code storage device according to claim 23, wherein the destination indicator is a destination media access control (“MAC”) address.

28. The program code storage device according to claim 23, wherein the instructions to indicate by the destination indicator that the data packet is to be delivered to the second InfiniBand node are performed by comparing the destination indicator to a known value.

29. The program code storage device according to claim 28, wherein the known value is a range of media access control (“MAC”) addresses.

30. The program code storage device according to claim 23, wherein the remote virtual network interface is virtualized by implementing microcode in a network processor.

31. The program code storage device according to claim 20, wherein the remote virtual network interface is virtualized by implementing microcode in a set of integrated circuits.
